(19) United States
(12) Patent Application Publication
(10) Pub. No.: US 2014/0120419 A1
(43) Pub. Date: May 1, 2014

(54) CARBON NANOTUBE GROWTH ON COPPER SUBSTRATES

(71) Applicant: APPLIED MATERIALS, INC., Santa Clara, CA (US)

(72) Inventors: Victor PUSHPARAJ, Sunnyvale, CA (US); Gene Maramag, San Jose, CA (US)

(21) Appl. No.: 14/064,883

(22) Filed: Oct. 28, 2013

Related U.S. Application Data
(60) Provisional application No. 61/719,293, filed on Oct. 26, 2012.

(51) Int. Cl. H01M 4/1393; H01M 4/134; H01M 4/133; H01M 4/1395

(52) U.S. Cl. CPC H01M 4/1393; H01M 4/1395; H01M 4/134; H01M 4/133; Y10S 977/742; Y10S 977/948; B82Y 99/00
USPC 429/211; 427/122; 977/742; 977/948

(57) ABSTRACT

A method of forming carbon nanotubes on a copper substrate may comprise providing a copper substrate, depositing a titanium metal thin film adhesion layer on the copper substrate, depositing a titanium nitride thin film on the titanium metal thin film, the titanium nitride thin film being between 100 and 200 nanometers in thickness, depositing a catalyst metal on the titanium nitride thin film, the catalyst metal being in the form of discrete particles on the surface of the titanium nitride thin film, and growing carbon nanotubes on the discrete particles of catalyst metal, the carbon nanotubes being grown to an average length of at least 3 microns, wherein the titanium nitride thin film is a diffusion barrier layer preventing alloying of copper with the catalyst metal. To form a silicon battery electrode, the method may further include depositing silicon on the carbon nanotubes over their entire length.

### CROSS-REFERENCE TO RELATED APPLICATIONS

This application claims the benefit of U.S. Provisional Application No. 61/719,293 filed Oct. 26, 2012.

This invention was made with U.S. Government support under Contract No. W15P7T-10-C-A607 awarded by the U.S. Department of Defense. The Government has certain rights in the invention.

### FIELD OF THE INVENTION

The present invention relates generally to methods for growing carbon nanotubes, and specifically to growing long carbon nanotubes on copper substrates.

### BACKGROUND OF THE INVENTION

Improved methods for growing long (tens of microns) carbon nanotubes on copper substrates are desired for various applications, including for example forming battery electrodes and semiconductor device interconnects.

### SUMMARY OF THE INVENTION

In embodiments, a method of forming carbon nanotubes on a copper substrate may comprise: providing a copper substrate; depositing a titanium metal thin film adhesion layer on the copper substrate; depositing a titanium nitride thin film on the titanium metal thin film, the titanium nitride thin film being between 100 and 200 nanometers in thickness; depositing a catalyst metal on the titanium nitride thin film, the catalyst metal being in the form of discrete particles on the surface of the titanium nitride thin film; and growing carbon nanotubes on the discrete particles of catalyst metal, the carbon nanotubes being grown to an average length of at least 3 microns; wherein the titanium nitride thin film is a diffusion barrier layer preventing alloying of copper with the catalyst metal. To form a silicon battery electrode, the method further includes depositing silicon on the carbon nanotubes over their entire length.

In further embodiments, a silicon electrode for a lithium ion battery, may comprise: a copper substrate; a titanium metal thin film adhesion layer on the copper substrate; a titanium nitride thin film on the titanium metal thin film; a catalyst metal on the titanium nitride thin film, the catalyst metal being in the form of discrete particles on the surface of the titanium nitride thin film; carbon nanotubes on the discrete particles of catalyst metal, the carbon nanotubes having an average length of greater than 40 microns; and a silicon coating over the entire length of the carbon nanotubes; wherein the titanium nitride thin film is a diffusion barrier layer preventing alloying of copper with the catalyst metal.

Yet further embodiments include cluster and in-line tools configured for the growth of long carbon nanotubes on copper substrates according to the aforementioned process.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 shows a representation of CNTs grown on a Ni/TiN/Ti/Cu stack on a substrate, according to some embodiments of the present invention;

FIG. 2 shows a representation of the CNTs of FIG. 1 with silicon deposited on the CNTs within the forest of long CNTs, according to some embodiments of the present invention;

FIGS. 3(a)-(c) are electron micrographs of long CNTs (approximately 45 microns long) formed on a Ni/TiN/Ti/Cu stack on a substrate, according to some embodiments of the present invention;

FIG. 4 shows a process flow for a silicon battery electrode embodiment, according to some embodiments of the present invention;

FIG. 5 shows a schematic representation of a cluster tool, according to some embodiments of the present invention; and

FIG. 6 shows a schematic representation of linear tool, according to some embodiments of the present invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The present invention is related to a process for growing carbon nanotubes (CNTs) on copper substrates/strips. The growth of CNTs on Cu substrates is quite challenging due to the CNT growth process requiring a high temperature—the temperature being high enough for the catalyst particles to alloy with the Cu substrate. Hence, to grow ultra-long CNTs, for use as an anode electrode in a Li-ion battery for example, an electrically conductive barrier layer is used to prevent alloying. The electrically conductive barrier layer will also help to minimize the interfacial resistance between the CNTs and the Cu strip and also promote a high yield CNT growth process. The barrier layer thickness needs to be controlled to enable long CNT growth, otherwise the CNTs may be of much shorter length (perhaps only 2 microns) and lower yield. A barrier layer with controlled thickness—see below for specific details—enables growth of CNTs on a copper substrate which are on average greater than 3 microns long, in embodiments greater than 10 microns long, in some embodiments greater than 20 microns long, and in further embodiments greater than 40 microns long. The present invention may be used in the formation of Li-ion batteries, as described in more detail below; furthermore, the principles and teaching of the present invention may also be applied to forming interconnects and vias in semiconductor integrated circuit devices.

A high surface area electrode is desired in a Li-ion battery. CNTs provide a high surface area, when compared with a planar surface, and they function as the basis of an effective anode electrode for Li-ion batteries. For the anode electrode copper is used as a current collector, hence the CNTs must be grown on the copper electrode to improve the electrode capacity. An electrically conducting barrier layer between the copper and the CNT catalyst is used to prevent alloy formation between the catalyst and the copper and to promote effective growth of the CNTs.

Carbon nanotubes (CNTs) have electrical and mechanical properties that make them attractive for integration into a wide range of electronic devices, including semiconductor devices. Carbon nanotubes are nanometer-scale cylinders with walls formed of graphene—single atom thick sheets of graphite. Nanotubes may be either single-walled (cylinder wall composed of a single sheet of graphene, referred to as SWNTs) or multi-walled (cylinder wall composed of multiple sheets of graphene, referred to as MWNTs). Nanotubes have diameters as small as one nanometer, for a SWNT, and length to diameter ratios of the order of 10²-10⁵. Carbon nanotubes can have either metallic or semiconducting electrical properties, which make them suitable for integration into a variety of devices and processes such as battery anodes, interconnects and vias for semiconductor integrated circuits, etc.

Carbon nanotubes can be grown using a variety of techniques including arc discharge, laser ablation and chemical vapor deposition (CVD), including hot wire CVD (HWCVD). CNTs are grown on catalyst particles, which generally are heat activated. The catalyst material may be a transition metal such as Co, Ni, and Fe, or a transition metal alloy such as Fe—Ni, Co—Ni and Mo—Ni. The catalyst particles are only 10's or 100's of Angstroms in diameter and are deposited by processes which may include PVD, CVD and ALD. CNT precursor compounds such as xylene, ethanol and ethylene, or mixtures of such compounds may be used.

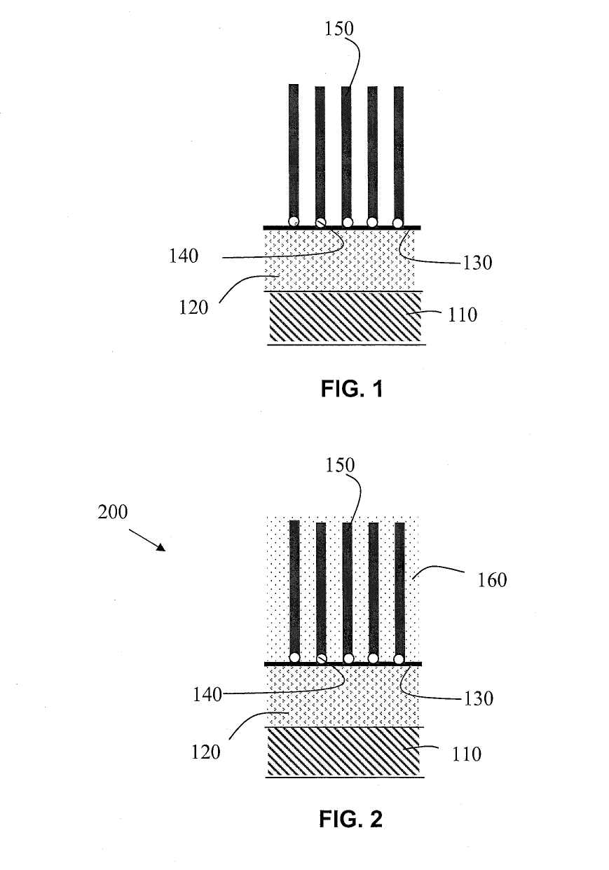

A specific example of a process for forming long CNTs on a copper covered substrate according to some embodiments of the present invention is provided as follows. FIG. 1 shows a representation of long CNTs 150 on a copper 120 covered substrate 110, and FIG. 2 shows a representation of these long CNTs coated in silicon 160, forming a high surface area electrode 200. The CNTs are deposited in a thermal hot wall CVD reactor. The CNTs are grown on a 50 micron thick copper substrate with an interfacial barrier layer 130. The barrier layer comprises Ti/TiN thin films, where the Ti layer provides better adhesion of the TiN to the copper. Barrier layer thin films were deposited by an Applied Materials PVD sputtering system. The thickness of the Ti film is typically between 150 nm and 250 nm and the thickness of the TiN film varies between 100 nm and 200 nm. A Ni catalyst 140 was deposited on the barrier layer by sputter deposition, with a thickness in the range of 0.3 nm to 3 nm. (Control of the density of catalyst particles is desired to control the density of CNTs—for applications such as the silicon battery electrode, 1-2% and up to 4% coverage of the surface area of the electrode may be desired to ensure silicon deposition, by a process such as chemical vapor deposition (CVD), can effectively penetrate the forest of CNTs to deposit silicon on the entire length of the CNTs; the deposition of a 0.3 nm to 3 nm thick layer of Ni as described above results in a density of catalyst particles within the desired range of 1-2% and up to 4% coverage of the surface area of the electrode.) The process to deposit CNTs on the barrier layer over the copper substrate is as follows: the deposition chamber is kept at atmospheric pressure of hydrogen/argon 15%/85%, and the substrate is held at 775° C. The growth rate of the CNTs scales up with increase in the deposition time. Hence to grow 45 micron long CNTs, the deposition time was approximately an hour. The carbon nanotube deposition was carried out using an ethylene gas precursor. Before the carbon deposition was carried out, the Ni/TiN/Ti/Cu strip/substrate was preheated in the chamber during the ramp up of the hot wall reactor temperature from room temperature to 775° C., which takes approximately an hour. The diameters of the CNTs are controllable and depend on the catalyst (Ni) particle sizes. The average diameter of the CNTs was 28 nm.

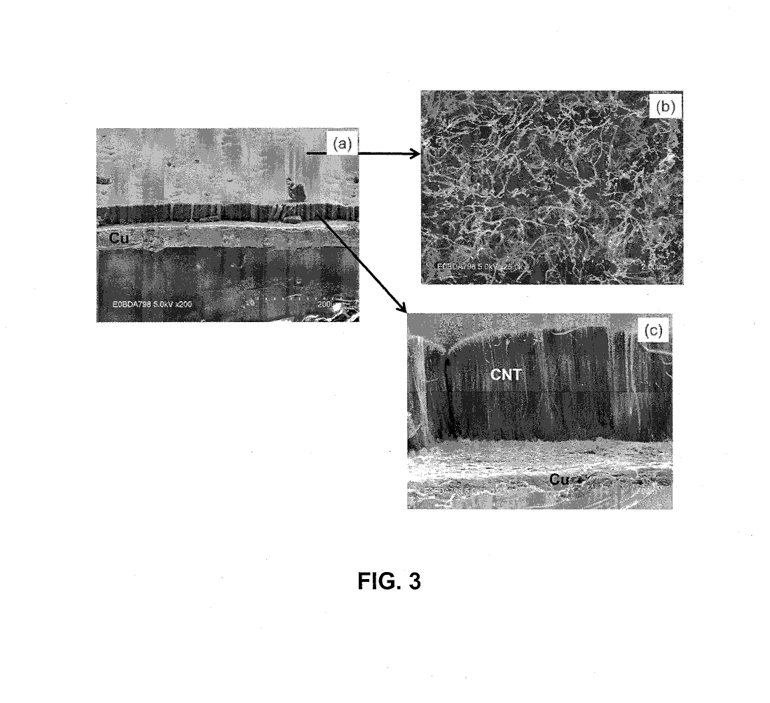

An example of long CNTs grown on a copper strip according to the process described above is shown in FIGS. 3(a)-(c), where FIG. 3(a) shows CNTs grown on the Cu substrate with a barrier layer, the CNTs having lengths of roughly 45 microns, FIG. 3(b) shows a top view of the CNTs of FIG. 3(a), and FIG. 3(c) shows a higher magnification cross sectional view of the CNTs of FIG. 3(a).

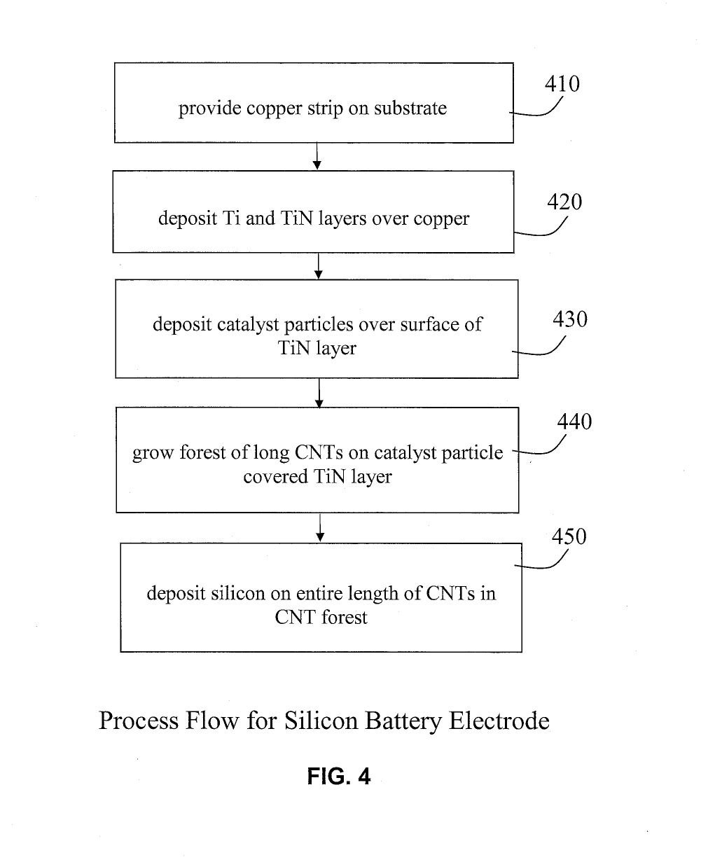

FIG. 4 shows a process flow for a silicon battery electrode according to some embodiments of the present invention, as illustrated in part in FIGS. 1-2. A method of fabricating a silicon battery electrode may comprise the following process steps, executed in the following order. A substrate covered with a copper strip is provided (410). A Ti adhesion layer and a TiN conductive barrier layer are deposited on the copper strip (420). Catalyst particles are deposited over the surface of the TiN layer (430). Long CNTs are grown on the catalyst particles, the CNTs being grown to a height of roughly 45 microns (440). Silicon is deposited, by a process such as CVD, on the CNTs within the “forest” of long CNTs (450).

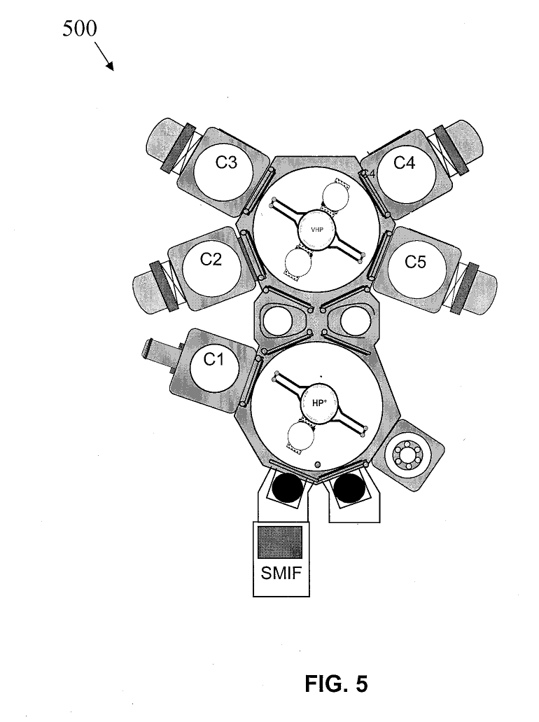

FIG. 5 is a schematic illustration of a processing system 500 for use in the process described above with reference to FIGS. 1-2 and 4. The processing system 500 includes a standard mechanical interface (SMIF) to a cluster tool equipped with process chambers C1-C5, which may be utilized in the dry deposition process steps described above. For example, the chambers C1-C5 may be configured for the following process steps: adhesion and barrier layer deposition; catalyst deposition; CNT deposition; and silicon deposition. Examples of suitable cluster tool platforms include Applied Material's Endura™, and Centura™ for smaller substrates. It is to be understood that while a cluster arrangement has been shown for the processing system 500, a linear system may be utilized in which the processing chambers are arranged in a line without a transfer chamber so that the substrate continuously moves from one chamber to the next chamber.

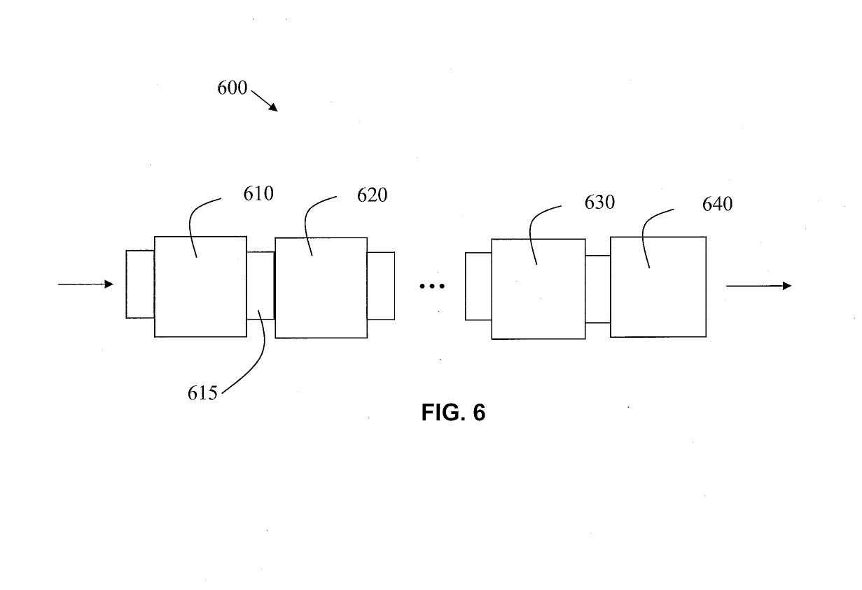

FIG. 6 shows a representation of an in-line fabrication system 600 with multiple in-line tools 610, 620, 630, 640, etc., according to some embodiments of the present invention. In-line tools may include tools for all of the deposition steps required for the process described above with reference to FIGS. 1-2 and 4. Furthermore, the in-line tools may include pre- and post-conditioning chambers. For example, tool 610 may be a pump down chamber for establishing a vacuum prior to the substrate moving through a vacuum airlock 615 into a deposition tool 620. Some or all of the in-line tools may be vacuum tools separated by vacuum airlocks 615. Note that the order of process tools and specific process tools in the process line will be determined by the particular process flow being used—specific examples of which are provided above. Furthermore, substrates may be moved through the in-line fabrication system oriented either horizontally or vertically. A suitable in-line platform for processing tool 600 may be Applied Materials Aton™.

According to further embodiments of the present invention, a continuous substrate may be used and the deposition processes may utilize web tools.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method of forming carbon nanotubes on a copper substrate comprising:
providing a copper substrate;
depositing a titanium metal thin film adhesion layer on said copper substrate;
depositing a titanium nitride thin film on said titanium metal thin film, said titanium nitride thin film being between 100 and 200 nanometers in thickness;
depositing a catalyst metal on said titanium nitride thin film, said catalyst metal being in the form of discrete particles on the surface of said titanium nitride thin film; and
growing carbon nanotubes on said discrete particles of catalyst metal, said carbon nanotubes being grown to an average length of at least 3 microns;
wherein said titanium nitride thin film is a diffusion barrier layer preventing alloying of copper with said catalyst metal.

2. The method of claim 1, wherein said titanium metal thin film is between 150 and 250 nanometers in thickness.

3. The method as in claim 1, wherein said catalyst metal is nickel metal.

4. The method as in claim 1, wherein said carbon nanotubes are grown to an average length of at least 10 microns.

5. The method as in claim 1, wherein said carbon nanotubes are grown to an average length of at least 20 microns.

6. The method as in claim 1, wherein said carbon nanotubes are grown to an average length of at least 40 microns.

7. The method as in claim 1, wherein said growing is in a hot wall chemical vapor deposition reactor at a temperature of approximately 775° C., under atmospheric pressure of hydrogen and argon, and using an ethylene gas precursor.

8. The method as in claim 1, further comprising depositing silicon on said carbon nanotubes.

9. The method as in claim 8, wherein said silicon is deposited over the entire length of said carbon nanotubes.

10. The method as in claim 8, wherein said catalyst metal has an average thickness on the surface of said titanium nitride thin film of between 0.3 and 3 nanometers.

11. The method as in claim 8, wherein said catalyst particles cover between 1% and 2% of the surface area of said titanium nitride thin film.

12. The method as in claim 8, wherein said catalyst particles cover less than or equal to 4% of the surface area of said titanium nitride thin film.

13. The method as in claim 8, wherein said depositing silicon is by a chemical vapor deposition process.

14. A silicon electrode for a lithium ion battery, comprising:
a copper substrate;
a titanium metal thin film adhesion layer on said copper substrate;
a titanium nitride thin film on said titanium metal thin film;
a catalyst metal on said titanium nitride thin film, said catalyst metal being in the form of discrete particles on the surface of said titanium nitride thin film;
carbon nanotubes on said discrete particles of catalyst metal, said carbon nanotubes having an average length of greater than 40 microns; and
a silicon coating over the entire length of said carbon nanotubes;
wherein said titanium nitride thin film is a diffusion barrier layer preventing alloying of copper with said catalyst metal.

15. The silicon electrode as in claim 14, wherein said catalyst particles cover between 1% and 2% of the surface area of said titanium nitride thin film.

16. The silicon electrode as in claim 14, wherein said catalyst metal is nickel metal.

17. The silicon electrode as in claim 14, wherein said titanium nitride thin film is between 100 and 200 nanometers in thickness.

18. The silicon electrode as in claim 14, wherein said titanium metal thin film is between 150 and 250 nanometers in thickness.
